(19) United States
(12) Patent Application Publication
(10) Pub. No.: US 2003/0158874 A1
(43) Pub. Date: Aug. 21, 2003

(54) Systems and methods for faciliating the protection of personal assets from business obligations

(76) Inventors: Stanford A. Graham, Layton, UT (US); Devin H. Cox, Draper, UT (US); Mitchell Brinton, Salt Lake City, UT (US)

Correspondence Address: TRASK BRITT, P.O. BOX 2550, SALT LAKE CITY, UT, 84110, US

(21) Appl. No.: 10/340,540

(22) Filed: Jan. 10, 2003

Related U.S. Application Data
(60) Provisional application No. 60/347,689, filed on Jan. 11, 2002.

(51) Int. Cl. G06F 12/00

(52) U.S. Cl. 707/204

(57) ABSTRACT

Methods and systems for establishing, maintaining, or enhancing the corporate veil provided by a client company, such as a corporation, limited liability company, or the like. Information about the organization and operation of the client company is obtained, then evaluated for compliance with the laws of the relevant state or states to determine areas in which action by the client company may be needed to ensure that the corporate veil is in place. The methods and systems may facilitate the planning and conducting of meetings by the client company, as well as the archiving of minutes recorded or resolutions reached during the meeting. A database that includes archived organizational or operational documents and information may be electronically accessed by the client company. Reevaluation of whether the client company is in compliance with statutes that are relevant to its corporate veil is also periodically conducted.

### CROSS-REFERENCE TO RELATED APPLICATION

Under the provisions of 35 U.S.C. § 119(e), priority is claimed from U.S. Provisional Application Serial No. 06/347,689, filed on Jan. 11, 2002.

### BACKGROUND OF THE INVENTION

1. Field of the Invention

The present invention relates generally to systems and procedures for maintaining separation between the assets and activities of a company and those of the individuals that own or oversee operation of the company and, more specifically, to interactive systems for maintaining the shield provided by state business entity (e.g., corporation, limited liability company, limited liability partnership, etc.) statutes. In particular, the present invention relates to systems which automatically schedule activities necessary for establishing and maintaining the separation between the assets and activities of a company from those of the individuals involved with the company, as well as providing instructional guidelines for carrying out various activities of the company.

2. Background of Related Art

As those in the art of corporate law are well aware, when a company becomes the defendant in legal actions, the plaintiffs in such legal actions often seek relief not only from the company itself, but also from the principals of the company, including owners or members, directors, officers, and managers of the company. This is particularly true in situations where the assets of a company are not sufficient to meet the demands of the complaining party, which is typically in search of the “deepest” available “pockets,” or the party who has significant amounts of money.

If a company, such as corporation or limited liability company, has been properly operated, the assets of its principals are typically isolated by the so-called “corporate veil” or “corporate shield” from the claims of complaining parties. As used herein, the terms “corporate veil” and “corporate shield” are not to be construed as being limited to a certain type of business entity, but shall also be understood as being equally applicable to limited liability companies, limited liability partnerships, and other types of business entities that are intended to provide a distinction between business assets and liabilities and those of individuals who are associated with the business. Proper operation of a corporation or limited liability company, however, requires compliance with a great number of legal requirements. Among these requirements is the need for regular meetings for both the directors and shareholders of a corporation or for the members of a limited liability company. Also, meeting agendas and minutes may be required, or at least useful for establishing that the requisite meetings have actually taken place.

Certain documents are typically required to form and operate various types of business entities. For example, agreements to form a corporation and to make a so-called “S-election” may be executed when the organized business entity is a corporation. Similarly, a founders' agreement may be reached in the formation of a limited liability company. The state in which a business entity is required typically requires articles of incorporation or organization. Corporate by-laws are also typically executed to identify how the business entity will operate in certain situations. In the case of corporations, stock certificates are typically issued and a stock ledger maintained. The Internal Revenue Service (IRS) requires that certain forms be completed and filed. State tax forms, state and local business licenses, and the like may also need to be completed. Various other agreements that are associated with the organization or operation of business entities including financing agreements, personal guarantees, and the like. Annual and/or quarterly reports may also be required.

Typically, in order to establish and maintain the corporate veil, a company must retain the services of competent legal counsel, who may docket meeting dates and attend the requisite company meetings to ensure that they are being properly conducted, that appropriate records are being kept, and that other legal requirements are being met. In addition, competent legal counsel may provide guidance as to the documents and agreements that should be executed to establish and maintain the corporate entity or limited liability company as separate and distinct from the individual principals thereof. The high degree of attention by competent legal counsel that is often needed to establish, maintain, and enhance the corporate veil almost always results in a significant expenditure for attorney's fees, which may be undesirable to some companies and, particularly, to smaller companies.

As a result of the high cost of good corporate guidance, many small companies do without such guidance. These companies either rely on their own understanding of the relevant requirements or completely ignore such requirements, believing that the mere establishment of a corporate entity or limited liability company is sufficient to protect them from attacks by parties that have complaints against the company.

Accordingly, there is a need for a relatively inexpensive system and methods by which the principals of a company may be reminded of various documents and activities that will evidence the efforts of the principals to establish and maintain the corporate veil.

### SUMMARY OF THE INVENTION

The present invention includes systems and methods for providing client companies with information that is helpful in establishing that a corporation, limited liability company, or other business entity is being operated in such a manner that its principals should be afforded protection from personal liability from obligations of the client company.

By way of example only, the present invention includes a method by which the individuals who are associated with a client company are instructed to operate the company in compliance with the relevant corporate or business organization laws so as to shield these individuals from liability for the client company's obligations. Such a method may include a nonlegal evaluation of the client company's organizational and/or operational documents and providing the client company with appropriate feedback. As used herein, the terms “organizational documents” and “operational documents” include all of the documents that are generated in organizing and operating a company, including financial records and documentation, administrative documents (e.g., minutes, resolutions, etc.), and the like. Likewise, the terms “organizational information” and “operational information” are defined herein to include, without limitation, all information that is used in organizing and operating a company, including company information, personal information, financial information, administrative information, and the like. In particular, the presence or absence of certain types of documents or certain required provisions in documents may be evaluated.

A method according to the present invention may also assist a client company in scheduling, planning, and conducting necessary meetings, as well as follow-up with the client company to document the occurrence of each such meeting, as well as the particular issues that were discussed and resolved therein.

A method according to the present invention may additionally include periodic reevaluation of the organization and operation of a client company to update the principals of the client company as to actions that may be taken to develop, preserve, and enhance the corporate veil.

In addition, a method that incorporates teachings of the present invention may provide each client company with access to information that instructs the client company on actions that may be taken to develop, preserve, and enhance a strong corporate veil.

A system incorporating teachings of the present invention, which effects the inventive method, includes a system administrator and one or more client companies. In operation, the administrator collects company information from each client company, identifies areas in which the client company may benefit from further documentation or legal advice, reminds owners, principals, and other individuals associated with the client company of required meetings and, optionally, of other meetings that may benefit the client company, and provides the client company with guidelines on various aspects of its organization and operation to better establish a corporate veil for its owners and principals and to ensure that the corporate veil remains in place. Additionally, the system may include a library (e.g., in the form of a database or physical document storage) of information that demonstrates that a client company is operating in a manner that ensures that the corporate veil is in place.

In an exemplary embodiment, at least a portion of a system according to the present invention is automatically effected, as by one or more administrative computers and one or more client computers associated therewith (e.g., by way of the Internet or direct links). All of part of a system that incorporates teachings of the present invention may alternatively be effected manually, by account representatives, who are also referred to herein as “system administrators.” Of course, a system according to the present invention may also include a combination of automated and manually effected components.

Other features and advantages of the present invention will become apparent to those of ordinary skill in the art through consideration of the ensuing description, the accompanying drawings, and the appended claims.

### BRIEF DESCRIPTION OF THE DRAWINGS

In the drawings, which illustrate several exemplary features of preferred embodiments of various aspects of the present invention:

FIG. 1 is an organizational chart depicting interaction of various exemplary aspects of the present invention;

FIG. 2 is a flow chart illustrating a method by which the documents of a client company may be evaluated;

FIG. 3 is a flow chart depicting an example of the manner in which the method of the present invention is used to assist a client company in scheduling, planning, conducting, and following up on meetings;

FIG. 4 is a flow chart showing an example of a process that may be conducted if one or more invited individuals will not be attending a meeting of a client company;

FIG. 5 depicts an exemplary process flow for obtaining organizational and operational information from a client company and evaluating the same; and

FIG. 6 is a website map of an exemplary system of the present invention, which may be effected by use of the Internet.

### DETAILED DESCRIPTION

A method of the present invention includes processes for establishing, maintaining, and enhancing the limits on personal liability that are afforded to individuals who are associated with properly run corporations, limited liability companies, and other business entities. Such limits on personal liability are also referred to herein as “the corporate veil.” A system that incorporates teachings of the present invention includes means by which various processes of the inventive method are effected.

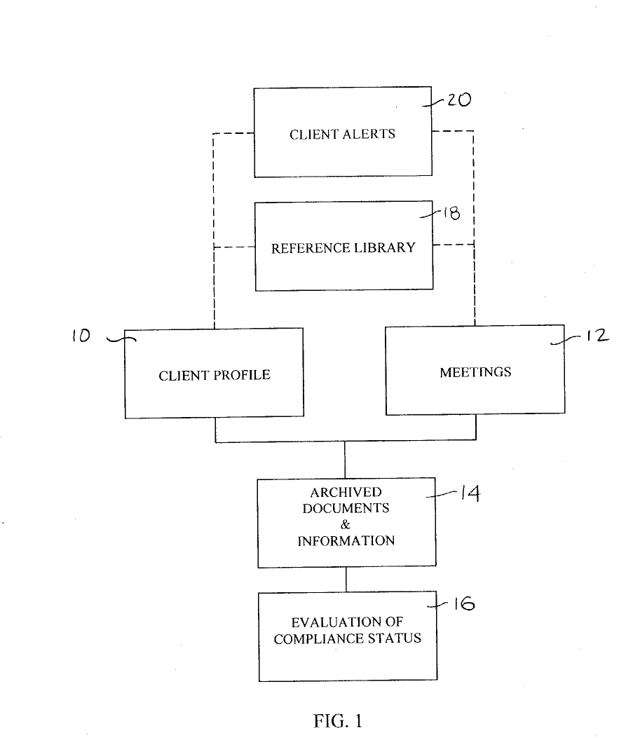

FIG. 1 depicts an overview of examples of processes that may be useful in order to establish, maintain, and enhance the corporate veil provided by a client company. Additionally, FIG. 1 illustrates an example of the interrelation between the depicted processes.

At reference character 10, a profile may be established for a client company. Such a profile is useful for evaluating the status of the corporate veil provided by the client company, as well as for identifying individuals who should be protected by the corporate veil and individuals who provide services that may be instrumental in establishing, maintaining, and enhancing the client company's corporate veil. In addition the company profile may include a list of corporate documents that have been produced by or on behalf of the client company.

The method of the present invention also includes, at reference character 12, actively participating in one or more of the scheduling and planning of the client company's legally required meetings, as well as in obtaining a record of the issues that were discussed and resolved during such meetings.

Documents that are obtained as a system administrator conducts the processes of reference characters 10 and 12, including organizational documents and records of company meetings, may be archived and indexed at reference character 14. The information included in such documents may then be used, at reference character 16, to facilitate an evaluation of whether or not the client company is in compliance with laws that relate to establishing, preserving, or enhancing the corporate veil. Such archiving may be effected in a variety of ways, including, without limitation, manually, as images (e.g., files in .pdf format), as text-searchable images (e.g., files in .pdf format in connection with optical character recognition (OCR) programming), text files, or the like.

Archived documents in hard copy (i.e., on paper) or computer-readable format (e.g., as e-mail attachments, on CD-ROM, etc.) may be provided to the client company as the client company requests the same. Alternatively, a client company's archived documents may be made available to and accessed remotely by one or more designated individuals who are associated with the client company. By way of example, such remote access may be effected by a direct remote connection or over the Internet. It is currently preferred that, when remote Internet access to the archived documents of a client company is provided, remote access be provided over a so-called “secure connection,” as known in the art.

In addition, a system incorporating teachings of the present invention may include making a reference library available for use by each client company, at reference character 18. Such a reference library may include materials that are useful for identifying issues that pertain to the structure of the client company, including the individuals who are associated with the client company and their respective roles, the organizational documents of the client company, and other specifics, as identified as a profile of the client company is obtained, at reference character 10. Additionally, a reference library may include materials that are useful in resolving various issues that are to be addressed in the client company's meetings, at reference character 12.

Another feature of a method and system according to the present invention, shown at reference character 20, may comprise following-up with a client company on issues concerning its organization, based on information provided as part of the profile of the client company, obtained at reference character 10. Likewise, a system that incorporates teachings of the present invention may include following-up with a client company in connection with one or more of the scheduling, planning, and reporting of meetings that are conducted by the client company, also at reference character 20. Such follow-up may be conducted manually (e.g., over the telephone) or automatically (e.g., by e-mail messages, by messages posted on a client company-dedicated web page, etc.).

### Initial Evaluation of Client Company Compliance Status

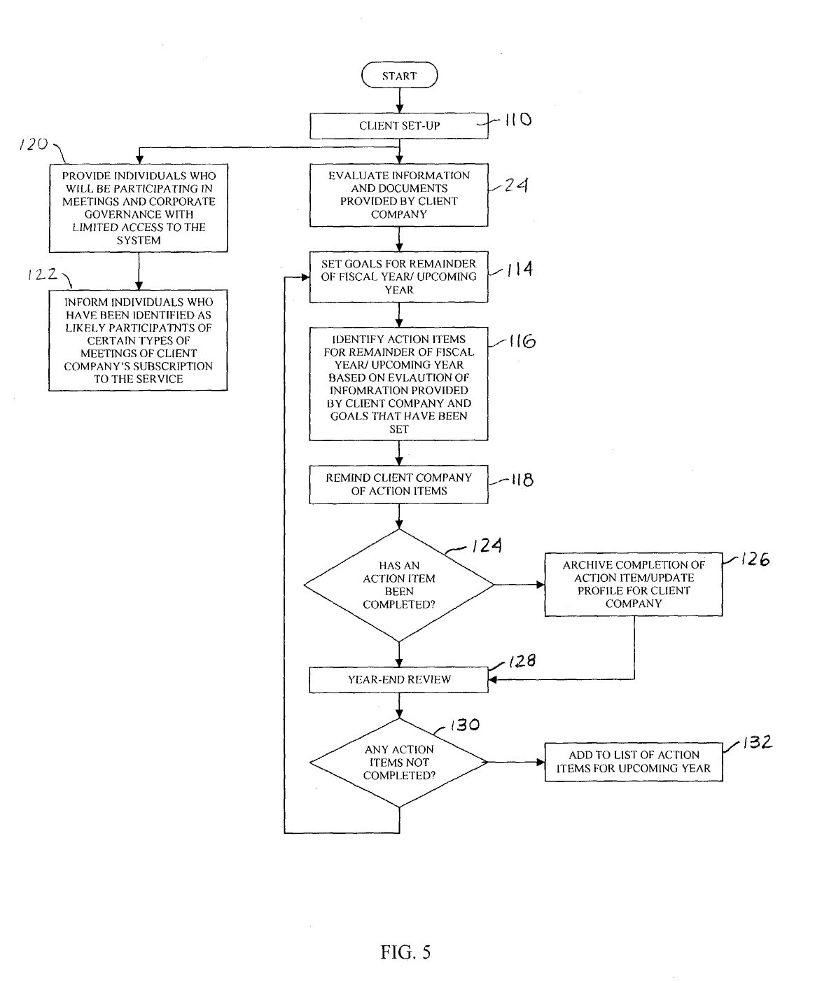

In one aspect, when a company becomes a subscriber to a system of the present invention, the system administrator first obtains a profile of a client company, as shown at reference character 110 of FIG. 5. Such a profile includes information about the state in which the client company is organized (e.g., incorporated in the case of a corporation), the states in which the client company does business, information on whether the client company has been registered to do business in the states where it conducts business, the location and contact information for the client company, the names and information regarding officers, directors, and shareholders of the client company, the name and relevant information for the client company's appointed agent, and the like.

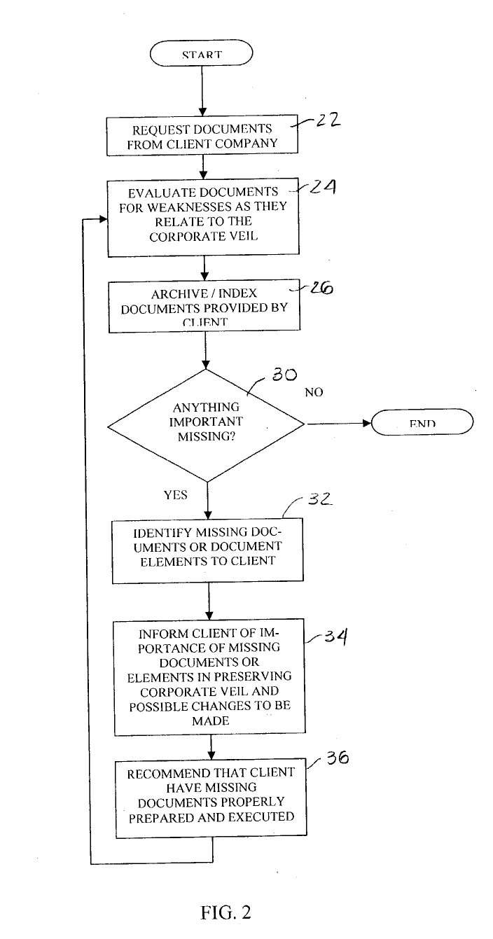

Turning now to the flow chart of FIG. 2, an example of the manner in which a profile of a client company may be obtained is illustrated. One aspect of obtaining a profile of a client company includes obtaining a list of the organizational and procedural documents and records that have been obtained, generated, and maintained by the client company. Accordingly, the process of obtaining a profile for a client company may include requesting that the client company provide copies of such documents, at reference character 22 of FIG. 2.

Optionally, once copies of such documents have been provided, they may be indexed and archived, at reference character 26. By way of example only, such indexing and archiving may be effected manually (i.e., in written or hard copy form) or electronically (e.g., as image type files, such as .pdf files).

The documents that have been provided by the client company may be evaluated at reference character 24. Such an evaluation may include a mere evaluation of the types of documents that have been provided by the client company. Additionally, a more detailed evaluation of the contents of the documents, including required provisions or other elements in such documents, may be effected.

If certain types of documents have not been provided, the client company is informed, at reference character 30, of the types of documents that it should have prepared, generated, or otherwise put into place. Also, at reference character 30, if one or more documents are missing any elements that are necessary to ensuring that the corporate veil is in place, the client company may be informed of the elements that are missing from the documents so that appropriate revisions may be made thereto. As shown at reference character 34, an indication of the importance of each missing document or element may accompany a report to the client company of any needed documents or elements. Also, a recommendation that any missing documents be prepared or revised by competent individuals, at reference character 36, may accompany a report of document deficiencies.

One or more follow-ups may be conducted (i.e., process flow may return to reference character 24) until the client company obtains or generates any missing documents and provides copies of the same to the system administrator.

Once a client company has all of the necessary documents in place, unless the relevant corporate or other business organization laws change, no further follow-up is needed. In the event that changes in the law do occur, the system administrator may inform the client company of any such changes, as well as any actions (e.g., changes to documents, new documents) that may be needed or desirable in view of each change in the law.

In addition, also at reference character 30, the client company may be informed of other possible deficiencies that could lead to piercing of the corporate veil, such as a single director, property ownership and use issues, the lack of certain types of professional advisors, or the like.

The purpose of such evaluations is to determine whether or not the client company has been organized and operates in compliance with the relevant business organization statutes and court decisions. In making such an evaluation, a system according to the present invention provides an indication as to the “compliance status” of the client company and, thus, of whether or not the client company provides an adequate corporate veil for its principals.

Any deficiency noted at reference character 30 may be added to a list of action items to be addressed by the client company before a scheduled reevaluation of the client company's compliance status is to be conducted.

Returning reference to FIG. 5, at reference character 114 thereof, various goals, or “action items,” may be set for an upcoming reevaluation time. These goals may include passing certain resolutions, changes in the organization of the client company, such as the addition of shareholders or members, obtaining financing, issuing additional shares of stock, or other goals the client company envisions achieving by a point in time for which reevaluation has been set. At reference character 116, these goals and any deficiencies in the documents provided by the client company are compiled as a list of action items to be completed by the upcoming reevaluation time. The point in time at which such reevaluation is to occur may be at the end of the current fiscal year, the end of the current calendar year, the end of the current or next quarter, or the like.

Optionally, the client company may be reminded of its action items at one more times before the reevaluation time, at reference character 118.

With continued reference to FIG. 5, after a client company has subscribed to a service that is effected by a system that incorporates teachings of the present invention, individuals who have been identified as directors, officers, shareholders, members, or representatives of the client company are informed of the client company's use of the services provided by the system, at reference character 120. Such notice may be provided by way of e-mail, a telephone call, or regular mail and may include a request for additional information if any of the information about that individual that was requested by the system was not completed in the initial client set-up, which occurred at reference character 110.

At reference character 122, each notified individual may be given limited access to the client company's information, as archived by the system. Such access may comprise access to a web page that provides the invited individual with information about an upcoming meeting. For example, the web page may permit the individual to view an agenda for the meeting, add items to the agenda, view the attendance status of the other individuals who have been invited to the meeting, as described in further detail hereinafter. Additionally, the individual may be provided with access to information about one or more past meetings, such as access to the archived minutes and resolutions from each such meeting.

### Meeting Minder

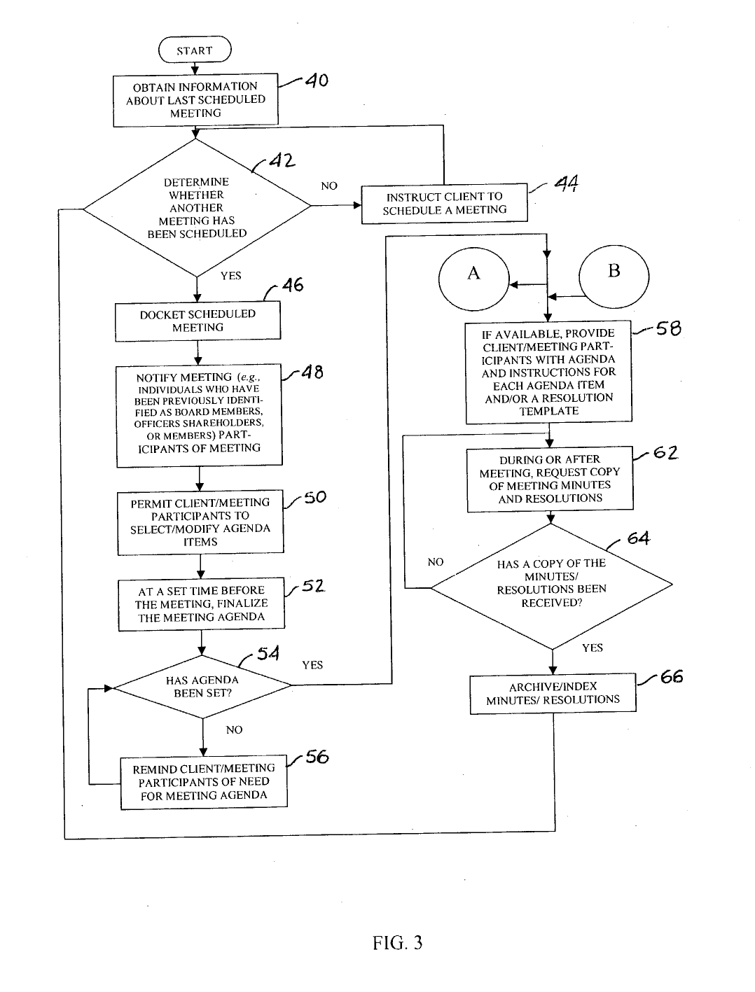

Another aspect of the present invention, referred to herein as the “meeting minder”, or meeting planner, aspect of the present invention, involves scheduling company meetings, reminding necessary individuals of meetings, providing them with guidance in planning such meetings, and following up with the individual participants of a meeting. Once the meeting has been conducted, the individuals who participated in the meeting may be asked to provide information from the meeting, including meeting minutes, task and associated scheduling information, or the like. This information may then be stored for the client company. Additionally, when such information is provided, further reminders may be provided and appropriate follow-ups conducted to ensure that the client company is operating in such a way as to shield the assets of its principals and owners. These activities are individually and collectively referred to herein as the “meeting minder” aspect of a method and system that incorporate teachings of the present invention. An exemplary process flow for the “meeting minder” aspect of the present invention is depicted in FIG. 3.

When a new client company subscribes to a system according to the present invention, information is obtained, at reference character 40, about the new client company's last scheduled meeting. By way of example, if the client company is a corporation, a system administrator would obtain information on when, if ever, the most recent shareholder and board of director meetings were conducted. As another example, for clients that are limited liability companies, the system administrator would obtain information about when the members of the limited liability company last formally met. Optionally, the system administrator may obtain information about and generate an independent record of the dates on which all of the client company's legally required meetings were conducted.

In addition to information about the most recent meeting, other information may be obtained from a client company. For example, information about the desired types of meetings, the number of meetings of each type, and the scheduling of such meetings may be obtained in accordance with teachings of the present invention. Such information may be obtained from a representative of the client company, by evaluating the client company's documents at reference character 28 of FIG. 2, or a combination thereof.

At reference character 42, an inquiry may be made as to whether or not the client company has scheduled any future meetings. Such scheduling may be set forth in the client company's organizational documents (e.g., the Articles of Incorporation). If no meetings have been scheduled, process flows to reference character 44, where the client company is instructed to schedule a meeting. Instructions of this type may include a recommended or required (as set forth in the organizational documents of the client company) time-frame during which such a meeting should occur. If the organizational documents of the client company require that a meeting occur on a specific date, the client company may be instructed at reference character 44 to verify that it will conduct the meeting on that date. Process flow then returns to reference character 42 until a meeting has been scheduled or a scheduled date for a meeting has been accepted.

As an alternative to providing a client company with reminders that meetings need to be scheduled, a system incorporating teachings of the present invention may schedule each such meeting. Such scheduling may be performed automatically (e.g., by a processor of a system server) or by a. system administrator and is typically performed in accordance with the requirements of the state in which the client company has been organized and with any dates or guidelines that have been set forth in the organizational documents of the client company.\

As another alternative, a representative of a client company may schedule a special meeting, such as when it becomes necessary for the directors, officers, or owners (e.g., shareholders, members, etc.) to make a particular decision. By way of example only, special meetings may be scheduled when it becomes necessary to make large capital expenditures, when it becomes necessary for the client company to obtain additional financing, when the client company needs to lease or purchase real estate, when the client company becomes involved in litigation, or for other reasons. A special meeting may be scheduled, for example, as a representative of the client company selects the appropriate link on a web page of a system of the present invention which has been dedicated to the client company.

Once a meeting has been scheduled, process flows to reference character 46, where the scheduled meeting is docketed. By docketing upcoming meetings for a client company, a method and system that incorporates teachings of the present invention may provide the client company with reminders of each upcoming meeting. Such reminding may be conducted automatically, such as by e-mail message, by providing the client company with an alert on a web page that has been dedicated to the client company, by mailing a written reminder to one or more individuals at the client company, or by similar notification means. Alternatively, a telephone call or another manual reminder may be provided to one or more individuals at the client company. As another alternative, a client company may be notified of an upcoming meeting by a combination of automatic and manual reminders.

Such a reminder may emphasize the importance of meetings in making sure that a company (e.g., a corporation, limited liability company, etc.) is run as mandated by law and, if the company is operated in the appropriate fashion, ensure that the company provides a strong corporate veil.

Additionally, as indicated at reference character 48, the individuals who are notified of an upcoming meeting are those who have been previously identified (e.g., as the system administrator is initially provided with information about the client company) as attendees of that type of meeting (e.g., board members for board meetings, shareholders for shareholder meetings, etc.). Alternatively, a representative of the client company may be reminded of the meeting and asked to identify people who are to be invited to the meeting. In either event, each notified person may cause the inventive system to invite other individuals to an upcoming meeting. Such notice may be provided and inquiry made at a predetermined period of time (e.g., one month, two weeks, etc.) before the meeting is to occur. Those people who have been identified as invitees to the meeting may also be notified of the time and location of the meeting at reference character 48.

Once the necessary individuals are notified of the meeting, they may be asked to indicate whether or not they will be able to attend the meeting.

In addition, the individuals who are notified of the meeting may be provided with an opportunity, at reference character 50, to identify topics that should be discussed as part of the agenda for the meeting. A library of typical agenda items may be accessed by the individuals who are to participate in the meeting. Additional information about the usefulness of each agenda item may accompany the library listing of that agenda item or be linked thereto, thereby providing a mechanism by which the individuals that are associated with a client company may be educated on the appropriate manner in which the client company should be governed, operated, and owned and permitting these individuals to make decisions that will affect the client company in a positive way. Of course, agenda items that are customized to the client company and, thus, which may not be included in the library, may also be developed and selected by a meeting participant.

An example of an agenda item that may be discussed during the first meeting following enrollment in or subscription to a system according to the present invention may be a vote on whether to amend the by-laws of the client company to permit use of the system. It may be necessary, for example, to amend the by-laws of the client company to permit notices to be provided by e-mail and to permit proxy voting or waivers to occur over the Internet or by e-mail.

In forming the agenda, the appropriate individuals may consult with one another, as well as add or remove various agenda items. The system may inform the meeting participants of the individual who added or removed a particular agenda item. The ability to participate in forming the agenda for the meeting may have a time limitation, which expires a predetermined period of time (e.g., three days, twenty-four hours, twelve hours, etc.) before the meeting is to begin. At the expiration of that period of time, the agenda becomes final, as indicated at reference character 52. Alternatively, the individuals who have been identified as meeting participants may decide to finalize the meeting agenda (e.g., by common consent, majority vote, or otherwise) and may do so by informing the system that the agenda has been finalized (e.g., by clicking a “START MEETING” “button” or link on a client company-dedicated web page, by e-mail, etc.).

At reference character 54, a determination is made as to whether or not a final agenda for the upcoming meeting has been set. If not, the individuals who have been identified as meeting participants are reminded, at reference character 56, of the need for an agenda, as well as of the importance of conducting meetings in the proper manner to preserve the corporate veil. Process flow then returns to reference character 54.

When the final meeting agenda is set, process flows to reference character 58. At reference character 58, a system incorporating teachings of the present invention (e.g., a processor of a system server, a system administrator, etc.) may generate or prepare a formal meeting agenda, which may include one or more areas at which minutes and resolutions may be entered. The formal meeting agenda may be provided to one or more of the meeting participants (e.g., a corporate secretary, a designated member of a limited liability company, etc.) in electronic or tangible form. By way of example only, the final agenda may be provided to a designated individual as a form on a web page that has been dedicated for use by the client company and which communicates substantially in real-time with the system (e.g., a system server).

Also at reference character 58, a system according to the present invention may evaluate the selected agenda items. Based on such evaluation, appropriate supporting materials, such as instructions or guidelines for addressing one or more of the agenda items, may be provided, at reference character 58, along with a final meeting agenda, to the identified meeting participants. Such instructions or guidelines may comprise generic lists of information to obtain and issues that should be discussed before making a decision with respect to a particular agenda item. Alternatively, the instructions or guidelines that are provided to the participants of a meeting may be tailored to the needs of the client company. In either event, such instructions or guidelines may be useful for assisting the participants of the meeting in making decisions in a way that will ensure that the client company is being operated in such a way as to protect the assets of the client company's owners and principals from potential claims. Other examples of supporting materials that may be provided with a final agenda include form documents that will facilitate discussion of certain contractual terms to be agreed upon and pursued by the client company in its relationships with other organizations or individuals.

As the final agenda is made available or provided to the individuals who will be participating in the meeting, they may also be reminded of the importance of adhering to the meeting agenda, as well as any supporting material provided therewith. For example, the meeting participants may be reminded that, by following the meeting agenda and using the accompanying supporting materials in its meetings, the client company will operate in a manner that evidences that the client company is operating as legally intended, not as an extension of or for the sole benefit of the individuals who own or operate the company.

As an example of the manner in which the final agenda may be made available or provided, the individuals who have been identified as participants of the meeting may receive an e-mail informing them that the final agenda for a meeting is available. Such an e-mail may include a so-called “link” to a webpage that includes the final agenda. By selecting, or “clicking”, such a link, each informed meeting participant may view, download, and/or print the final agenda for the meeting.

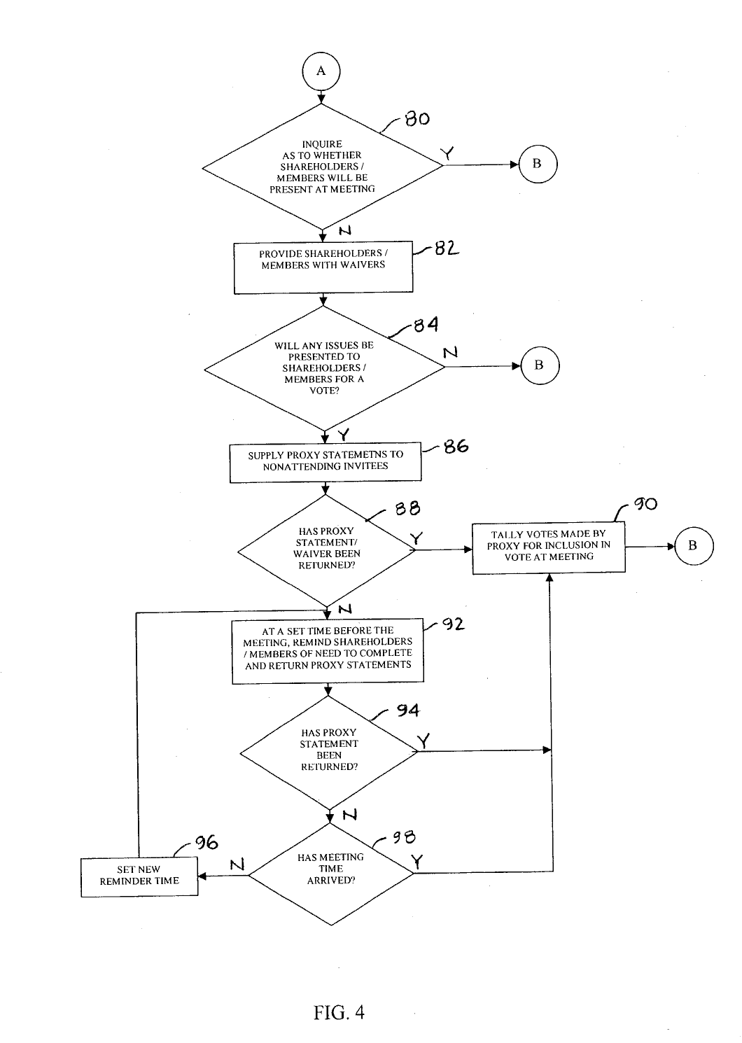

At reference character A, process may flow to FIG. 4, where a determination is made as to which of the invited individuals will be attending the meeting.

At reference character 80, the meeting invitees are provided an opportunity to opt-out of attendance in the meeting. If none of the individuals who have been invited to an upcoming meeting indicates to the system that they will not be attending the meeting, process flows to reference character B and, thus, back to FIG. 3.

If, however, any of the meeting invitees chooses, at reference character 80, to opt-out of attending the upcoming meeting, process flows to reference character 82, where each individual who has been invited to the meeting but has chosen not to attend is provided with a waiver. Such a waiver may be provided as an e-mail, which may be returned by e-mail to a system of the present invention. Alternatively, a nonattending invitee may inform the system of a decision not to attend a meeting by clicking the appropriate “button” on a dedicated web page, in which case a waiver form may be displayed on the monitor of the nonattending invitee's computer, who may then complete and submit the waiver electronically to the system. As another alternative, a waiver in paper form may be sent to each individual who has been invited to but has decided not to attend an upcoming meeting, completed by that individual, and mailed back to a system administrator. Process then flows to reference character 84.\

At reference character 84, an inquiry is made as to whether or not any issues will be presented to directors, officers, shareholders, or members for a vote. Such a determination may be made by the individuals who have been invited to an upcoming meeting and communicated to a system incorporating teachings of the present invention. As an alternative, a system incorporating teachings of the present invention may determine, based on the items that appear on the final agenda, whether or not any issues will be voted on in the meeting.

If not, process flows to reference character B and, thus, back to FIG. 3. Of course, a follow-up may be conducted by the system to determine whether or not the individuals who have indicated that they will not be attending the upcoming meeting have returned their waivers. Further reminders may be provided, as desired.

If there are issues that will be voted on at the meeting, process flows to reference character 86 of FIG. 4, where any nonattending invitees are provided with a proxy statement. The proxy statement may be provided in the same manner as a waver (e.g., by e-mail, by linking the computer of the nonattending invitee to a web page that includes an electronic proxy statement, by regular mail, etc.). Process then flows to reference character 88.

At reference character 88, an inquiry is made by the system as to whether or not each proxy statement that has been provided to a nonattending invitee has been returned. If so, process flows to reference character 90, where all of the votes are provided to a representative of the client company who will be attending the meeting and tallied with the corresponding votes that are obtained at the meeting. Otherwise, process flows to reference character 92, where, at a set time before the meeting, the nonattending invitees are reminded (e.g., by e-mail, a telephone call, etc.) of the importance of their completion of and returning the proxy statement. Additional follow-up inquiries may be made, at reference character 94, and additional follow-up times set, at reference character 96, until the time that has been set for the meeting. Once the meeting time arrives, at reference character 98, process flows to reference character 90, where all of the returned proxy statements are collected and the votes of the nonattending invitees tallied with the votes of the individuals who are in attendance at the meeting.

Process then flows to reference character B and, thus, returns to FIG. 3.

With returned reference to FIG. 3, while a meeting is being conducted, the minutes of that meeting may be entered into an electronic form of the final agenda using a computer that is in communication with an appropriate web page of the system. In such a case, the minutes may be provided directly to the system (e.g., by “clicking” or selecting a “RECORD MINUTES/RESOLUTIONS” “button”) and stored, both in a manner known in the art, at reference character 62.

As an alternative to the direct entry of meeting minutes into a system that incorporates teachings of the present invention, the minutes may be kept separately. Once a meeting has been conducted, a system incorporating teachings of the present invention (e.g., a processor of a system server, a system administrator, etc.) may follow-up with one or more of the individuals who participated in the meeting, such as the Secretary of a client corporation or a designated member of a limited liability company, at reference character 62. By way of example, such a follow-up may include an automatic e-mail request for a copy of minutes from the meeting. Continued follow-ups may be required if inquiries, identified at reference character 64, indicate that such information has not been provided by an individual associated with the client company. The minutes maybe provided in tangible form (e.g., on paper) or electronic form (e.g., by text in a reply e-mail, as a .pdf file, etc.). Once information about the meeting, including minutes thereof, has been received by a system administrator, such information may be physically or electronically stored by a system according to the present invention, as shown at reference character 66.

If any resolutions are to be made at the meeting, a resolution template may be provided to a representative of the client company, at reference character 58. Any resolutions that are reached may then be documented by use of the template. The template may include the appropriate or required terminology, or “legalese,” to ensure that the resolutions are being made in the appropriate manner. Such documentation may be effected in electronic form and provided to a system of the present invention directly (e.g., by secure Internet connection, direct connection, etc.), in a similar manner to that described above with respect to providing minutes to the system, or indirectly (e.g., by subsequent e-mail). Alternatively, a separate document may be prepared by following the template, the provided to the system (e.g., in hard format by mail, electronically by e-mail, etc.). The system may then store or archive the resolutions. Follow-ups may also be conducted, as described above with respect to follow-ups for the minutes of a meeting.

Once a meeting has been closed and all of the appropriate information received by a system administrator, all of the information and documentation that resulted from the meeting, including nonresponses by meeting participants, failure to hold the meeting, and the like, may be documented and archived, at reference character 66.

Process flow then returns to reference character 42, where the next meeting is scheduled, if necessary, and the system awaits the appropriate time for providing the appropriate individuals with reminders.

### Review of Client Company Compliance Status

Another aspect of the present invention includes evaluation of how well a client company is complying with applicable organizational laws to ensure that the corporate veil remains in place for the client company and the individuals who are associated therewith. In addition, so called “weak spots” in the corporate veil of the client company, or deficiencies in the manner in which the client company has been organized and/or is being operated, may be identified. Such an evaluation is also referred to herein as an evaluation of the “compliance status” of the client company.

With returned reference to FIG. 5, during the course of business and by the reevaluation time that was set at reference character 116, a representative of the client company may indicate to a system of the present invention, at reference character 124, that one or more action items have been completed. The completion of these action items may be archived (e.g., by providing the system with copies of newly prepared and executed documents, revised documents, resolutions, etc.) and the profile of the client company updated, as appropriate, at reference character 126.

Whether or not the completion of any action items has been communicated to the system, reevaluation of the compliance status of the client company will occur, as shown at reference character 128, at or about the set reevaluation time. If it is determined at reference character 130 that any of the identified action items were not completed, those action items are transferred to the list of action items to be completed by the client company during the upcoming period of time (e.g., the next fiscal or calendar year or quarter, etc.), at reference character 132. Optionally, the minutes and resolutions from meetings that were conducted during the previous time period may be evaluated to identify any additional action items to be addressed by the client company during the upcoming quarter, year, or other set time period. Process flow then returns to reference character 114, where goals for the upcoming period of time are set.

While the flow charts of FIGS. 1 through 5 depict a series of acts being conducted in a particular, exemplary order, the present invention is in no way limited to the order presented herein. Likewise, a system that is within the scope of the present invention does not necessarily include all of the acts and features that have been described herein.

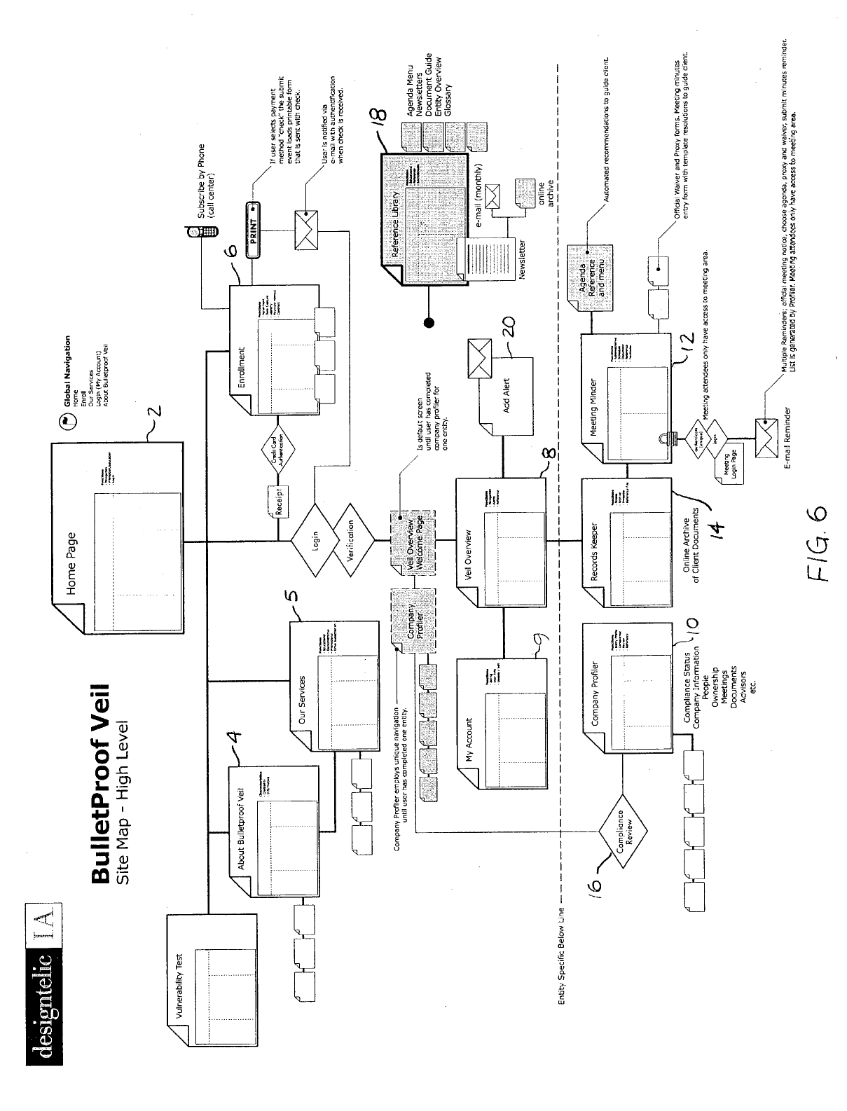

FIG. 6 is a “map” of an example of a website 1 that may comprise at least a portion of a system according to the present invention. As shown, website 1 may include a “home page” 2 from which other “pages” of website 1 may be accessed. For example, an information page 4, such as that entitled “About Bulletproof Veil” in FIG. 6, may be accessed from home page 2. Likewise, individuals who are associated with business entities that are interested in becoming subscribers to a service that includes a system of the present invention may enroll each such business entity at an enrollment page 6, such as the web page entitled “Enrollment” in FIG. 6.

Once a business entity becomes a subscriber, or client company, to the services that are provided by a system that incorporates teachings of the present invention, one or more designated individuals who are associated with that client company may gain access to additional pages, such as those identified in FIG. 6 as the “Veil Overview” page 8 and “My Account” page 9. From Veil Overview page 8, the designated individual may access other pages through which various aspects of the present invention, such as those depicted in FIG. 1, are effected. For example, client alerts, as shown at reference character 20 of FIG. 1, may be provided to designated individuals who are associated with a particular client company at an “Add Alert” feature 20 which is accessed through Veil Overview page 8. As another example, a profile of the client company may be obtained, as shown at reference character 10 of FIG. 1, through a “Company Profiler” page 10. A “Meeting Minder” page 12 provides a user-interface for planning, conducting, and following-up with meetings. A compliance review 16 of a particular client company may be effected in association with (e.g., by accessing information available on) the Company Profiler page 10 that has been dedicated to a particular client company. Archived records and documents may be accessed by one or more designated individuals associated with the client company, as indicated at reference character 14 of FIG. 1, through a “Records Keeper” page 14. Reference materials may be accessed through a “Reference Library” page 18 of website 1.

Of course, a website that incorporates teachings of the present invention may include other features or a different arrangement of features that those illustrated in FIG. 6 without departing from the scope of the present invention.

The present invention also includes a database by which a client company may gain access to indexed and archived documents and records. Each time documents or other information (e.g., scheduled meetings, final meeting agendas, supporting materials, minutes from meetings, etc.) are provided to the system administrator, the system administrator may index and archive such documents or other information. For example, the system administrator may provide a client company with access to archived documents and records by remote computer access (e.g., by way of a secure Internet connection, direct dial-up connection, or otherwise, as known in the art). Alternatively, the archived documents may be stored, in electronic format, on a suitable, portable medium, such as a CD-ROM. As another alternative, physical copies of documents and other information may be indexed and filed.

In another aspect, the present invention includes a method for marketing the inventive system to various companies. Appropriately, this aspect of the present invention is referred to herein as a marketing method. The marketing method includes recruiting vendors that already provide financial, investment, insurance, or other services to various companies. The vendors may then market subscriptions to a service which is conducted in accordance with the system to their existing client companies. Clients that obtain subscriptions to the service through such channels may be afforded reduced subscription rates, while the vendors may receive additional business as a client company is informed of deficiencies in its corporate veil that should be remedied and, as a result, the corporate veil provided by the client company is strengthened.

Although the foregoing description contains many specifics, these should not be construed as limiting the scope of the present invention, but merely as providing illustrations of some of the presently preferred embodiments. Similarly, other embodiments of the invention may be devised which do not depart from the spirit or scope of the present invention. Moreover, features from different embodiments of the invention may be employed in combination. The scope of the invention is, therefore, indicated and limited only by the appended claims and their legal equivalents, rather than by the foregoing description. All additions, deletions, and modifications to the invention, as disclosed herein, which fall within the meaning and scope of the claims are to be embraced thereby.

What is claimed is:

1. A method for facilitating one or more of establishment, maintenance, and enhancement of a corporate veil provided by a client company, comprising:
obtaining organizational and operational information from the client company;
archiving said organizational and operational information, including documents of the client company, for subsequent electronic access by the client company;
initially evaluating said organizational and operational information to identify at least one deficiency therein; and
reevaluating said organizational and operational information at least once to determine whether or not said at least one deficiency has been remedied by the client company.

2. The method of claim 1, wherein said obtaining includes obtaining copies of one or more organizational or operational documents from the client company.

3. The method of claim 2, wherein said archiving comprises electronically archiving said one or more organizational or operational documents.

4. The method of claim 3, wherein said electronically archiving comprises storing said one or more organizational or operational documents in a text-searchable format.

5. The method of claim 1, wherein said archiving comprises archiving said organizational and operational information for remote electronic access by the client company.

6. The method of claim 1, further comprising:
reminding the client company to remedy said at least one deficiency at least once before said reevaluating is effected.

7. The method of claim 1, further comprising:
facilitating planning of at least one meeting of the client company before said reevaluating is effected.

8. The method of claim 7, wherein said facilitating planning comprises notifying at least one designated individual associated with the client company of said at least one meeting.

9. The method of claim 7, wherein said notifying is effected electronically.

10. The method of claim 8, wherein said facilitating planning further comprises permitting said at least one designated individual to select at least one agenda item to be addressed during said at least one meeting.

11. The method of claim 10, further comprising providing said at least one designated individual with guidance relevant to said at least one agenda item.

12. The method of claim 8, wherein said facilitating planning further comprises permitting said at least one designated individual to identify at least another individual to be invited to said at least one meeting.

13. The method of claim 12, further comprising notifying said at least another individual of said at least one meeting.

14. The method of claim 13, wherein said notifying is effected electronically.

15. The method of claim 13, further comprising permitting said at least another individual to select at least one agenda item to be addressed during said at least one meeting.

16. The method of claim 15, further comprising providing said at another individual with guidance relevant to said at least one agenda item.

17. The method of claim 1, wherein said initially evaluating is effected manually.

18. The method of claim 1, wherein said initially evaluating comprises use of at least one of a checklist and an outline.

19. The method of claim 1, wherein said reevaluating is effected periodically.

20. The method of claim 19, wherein said reevaluating is effected at the end of a predetermined period of time.

21. The method of claim 1, wherein said reevaluating is effected manually.

22. The method of claim 1, further comprising:
periodically providing the client company with instructional materials on at least one aspect of establishing, maintaining, or enhancing the corporate veil.

23. A method for facilitating one or more of establishment, maintenance, and enhancement of a corporate veil provided by a client company, comprising:
electronically notifying at least one designated individual of a scheduled meeting;
permitting said at least one designated individual to electronically participate in creating an agenda for said scheduled meeting scheduled meeting;
generating said agenda; and
electronically providing said agenda for use in said scheduled meeting, said agenda including at least one location for electronic recordation of minutes relating to one or more items included in said agenda while said scheduled meeting is conducted.

24. The method of claim 23, further comprising:
electronically archiving said minutes.

25. The method of claim 24, wherein said electronically archiving is effected during said scheduled meeting.

26. The method of claim 23, further comprising:
permitting said at least one designated individual to file a waiver indicating an intent of said at least one designated individual not to attend said scheduled meeting.

27. The method of claim 26, further comprising:
providing said at least one designated individual with a proxy statement following receipt of said waiver.

28. The method of claim 23, further comprising:
permitting said at least one designated individual to identify at least another individual to be invited to said scheduled meeting.

29. The method of claim 28, further comprising:
notifying said at least another individual of said scheduled meeting.

30. The method of claim 29, further comprising:
permitting said at least another individual to electronically participating in creating said agenda.

31. The method of claim 23, further comprising:
electronically providing at least one template for at least one resolution to be made during said scheduled meeting, said at least one template including at least one location for electronic recordation of said at least one resolution while said scheduled meeting is conducted.

32. The method of claim 31, further comprising:
electronically archiving said at least one resolution.

33. The method of claim 32, wherein said electronically archiving is effected during said scheduled meeting.

34. A system for facilitating one or more of establishment, maintenance, and enhancement of a corporate veil provided by a client company, comprising:
a client company profiler for obtaining organizational and operational information from the client company;
a database in which said organizational and operational information, including documents of the client company, are archived for subsequent electronic access by the client company;
a meeting planner for scheduling, organizing, and documenting meetings conducted by the client company; and
a compliance evaluator for evaluating and reevaluating said organizational and operational information to identify at least one deficiency therein.

35. The system of claim 34, wherein said client company profiler comprises a page of a website into which an individual associated with the client company inputs at least some of said organizational and operational information.

36. The system of claim 34, wherein said database includes images of said documents.

37. The system of claim 35, further comprising:
an optical character recognition program associated with said images to facilitate text-searchikng thereof.

38. The system of claim 34, wherein said database also includes at least one of image files and text files of at least one of minutes and resolutions from at least one meeting of the client company.

39. The system of claim 34, wherein said meeting planner comprises a system server configured to electronically effect at least one of the following:
notifying at least one designated individual associated with the client company of at least one scheduled meeting;
permitting said at least one designated individual to at least partially create an agenda for said at least one scheduled meeting;
providing said agenda, along with at least one location for recordation of at least one of meeting minutes and resolutions, for use during said meeting; and
archiving said meeting minutes or said resolutions.

40. The system of claim 34, further comprising:
an electronic library of materials relating to at least one of establishing, maintaining, and enhancing the corporate veil of the client company.

41. The system of claim 34, wherein at least one of said client company profiler, said database, and said meeting planner comprises at least one server configured to communicate remotely with at least one designated individual associated with the client company.

42. The system of claim 41, wherein said at least one server is configured to communicate with said at least one designated individual over the Internet.
